(19) United States
(12) Patent Application Publication
(10) Pub. No.: US 2014/0289641 A1
(43) Pub. Date: Sep. 25, 2014

(54) Adaptive User Interface

(71) Applicant: Jerome Eymard WHITCROFT, Main Beach (AU)

(72) Inventor: Jerome Eymard WHITCROFT, Main Beach (AU)

(21) Appl. No.: 14/219,362

(22) Filed: Mar. 19, 2014

(30) Foreign Application Priority Data
Mar. 20, 2013 (AU) 2013901047

(51) Int. Cl. G06F 3/0482

(52) U.S. Cl. CPC G06F 3/0482
USPC 715/745

(57) ABSTRACT

A system and method for issuing an instruction includes a parsed hierarchical list including a parent level with parent nodes, and a child level with child nodes. The child level is associated with at least one parent node, each parent node associated with a parent label, the child nodes being associated with a child label. Selectable labels are displayed, each respective label corresponding to a respective parent label with a spatial arrangement corresponding to predetermined criteria. A first label selection is received from an input device and replaced with a second selectable label plurality in a spatial arrangement. Each second selectable label corresponds to a respective child label, the spatial arrangement corresponding to predetermined criteria. A second selection from the second plurality of labels is received from the input device, and an instruction for execution by a computer processor is executed based on the second selection.

### CROSS REFERENCE TO RELATED APPLICATION

This application claims priority in Australian Patent Application no. 2013901047 filed 20 Mar. 2013, the contents of which are incorporated by reference.

### TECHNICAL FIELD

The present invention relates to methods and systems for facilitating the issuance of an instruction for execution by a computer processor, for example, as the result of operating a user interface of a computing system.

### BACKGROUND

Modern computing systems use a variety of user interfaces to facilitate their operation by users. Conventionally, a keyboard and a pointing device (such as a mouse) are used to interact with computing systems. More recently, gesture-based systems, and touch-sensitive screens, have broadened the ways in which computers can be given instructions.

At their most basic level, these systems enable a user to give commands to a computing system, generally with reference to an exposed user interface (which may be visual, audible, or both).

One disadvantage of conventional user interfaces is that the user must understand, and have sufficient familiarity with, the user interface commands that are understood by the software being executed on the computing system. Graphical user interfaces provide the user with visual indications of where to activate a pointing device (by means of menus, buttons and the like). However, to achieve a desired result, a user must often activate a specific combination of menu items or buttons (in a specific order). As software becomes more complicated, the number of menu items, buttons, or other activation mechanisms proliferate. In addition, each software program has its own user interface. This provides a barrier for users unfamiliar with the software, such as new users, and those with disabilities that inhibit their ability to navigate complicated user interfaces. On-line contextual help screens have been developed to address this drawback, but are time consuming for the user to absorb and remember.

Although there have been recent advances in natural language speech processing for human-computer interaction, speech-based user interfaces are unable to be used in noisy or shared environments.

It is desired to address or ameliorate one or more of the aforementioned shortcomings or disadvantages of the prior art, or at least provide a useful alternative.

### SUMMARY OF THE INVENTION

In at least one embodiment, the present invention provides a computer-implemented method for issuing an instruction, the method including the steps of:

parsing a hierarchical list, the hierarchical list including a parent level having one or more parent nodes, and a child level having one or more child nodes, the child level being associated with a selected one of the one or more parent nodes, wherein the one or more parent nodes are each associated with a parent label and the one or more child nodes are each associated with a child label;

displaying a first plurality of selectable labels in a spatial arrangement, each of the respective first plurality of labels corresponding to respective parent labels and the spatial arrangement corresponding to one or more predetermined criteria;

receiving, from an input device driver, a first selection of one of the first plurality of selectable labels;

replacing the first plurality of selectable labels in the spatial arrangement with a second plurality of selectable labels in a spatial arrangement, each of the second plurality of selectable labels corresponding to respective child labels, the spatial arrangement corresponding to one or more predetermined criteria;

receiving, from the input device driver, a second selection of one of the second plurality of labels; and issuing an instruction for execution by a computer processor based on the second selection.

The predetermined criteria preferably includes one or more of current user label selection information, historical user label selection information, user defined label selection or a combination thereof.

Advantageously, the present invention allows for a spatial arrangement based on predetermined criteria which may include historical user selections or related to the task currently being undertaken. Further, the predetermined criteria may include a user's previous uses of the system, or the predetermined criteria may be tied to a third-party commercial imperative (for example a promotional product) or may be the users preferred layout.

The parsed hierarchical list may include at least one of a text to be displayed, an image or an object. The spatial arrangement of the selectable labels preferably includes the size and position of the selectable label such that the size and position of the selectable label is based on a combination of current user label selection information and historical user label selection information. Advantageously, this allows spatial arrangement of the selectable labels such that the labels in some label positions are easier to select than labels in other positions. For example, some label positions may be larger, and hence easier to activate or better positioned than other labels. For example, some label positions may take less effort to reach (such as those in the centre of an arrangement, or those corresponding to the home keys of a computer keyboard). Advantageously, the present invention may arrange the selectable labels so that the labels most likely to be selected are in positions where they are more easily selected.

Preferably, the step of displaying the first plurality of selectable labels in a spatial arrangement includes the step of displaying the first plurality of selectable labels in predetermined arrangement and in an order determined, at least in part, by the order of the parent nodes within the parent level of the hierarchical list.

Preferably, the step of replacing the first plurality of selectable labels with the second plurality of selectable labels includes the step of displaying the second plurality of labels in an arrangement determined, at least in part, by the order of the child nodes within the child level of the hierarchical list.

In an embodiment, the method further including the steps of: modifying the order of the nodes within the hierarchical list based on one or both of the first selection and second selection;

storing the modified list in a computer readable storage medium for subsequent reuse.

The step of modifying the order of the nodes within the hierarchical list may include modifying the order of the nodes based on inputs previously received when one or more of the first plurality of selectable labels and the second plurality of selectable labels have been displayed.

The step of issuing an instruction may include includes the step of issuing an instruction to launch a software program for example. Alternatively, the step of issuing an instruction may include the step of issuing an instruction to execute a function of a software program. The step of issuing an instruction may include the step of issuing an instruction to execute a search query, the contents of the query being determined, at least in part, by the second selection. Preferably, the selectable labels represent refinements of a search query.

The spatial arrangement may correspond to the physical layout of an input device such as a keyboard for example. In an embodiment, the selectable labels relate to a task to be completed by a user.

In at least one embodiment, the present invention provides a system for issuing an instruction for execution by a computer processor, the system including:

a hierarchical list traversal component for traversing a hierarchical list, the list including a hierarchy of nodes representing user choices, and a plurality of nodes at the bottom of the hierarchy representing instructions executable by computer processor;

a display component for displaying a predetermined spatial arrangement populated with labels based on received label information;

an input processing component for processing input data received from an input device driver and generating user label selection information;

a list modification component for modifying a hierarchical list based on user label selection information, wherein the list modification component is configured to modify a hierarchical list based on one or more predetermined criteria; and

a control component for;

receiving user label selection information from the input processing component, the user label selection information identifying a selected label;

if the selected label is associated with a node representing instructions executable by a computer processor,

issuing one or more instructions for execution by a computer processor based on information derived from the node, otherwise,

sending traversal instructions to the hierarchical list traversal component based on the user label selection information;

receiving next node information from the hierarchical list traversal component, the next node information relating to one or more nodes dependent from the node in the hierarchical list corresponding to the selected label; and

generating label information from the next node information, and sending the label information to the display component.

The predetermined criteria preferably includes one or more of current user label selection information, historical user label selection information, user defined label selection or a combination thereof.

Advantageously, the system of the present invention modifies the hierarchical list to re-order the nodes within the list (and hence the position of the labels within the spatial arrangement) which allows for dynamic label position allocation.

An algorithm (such as one based on Bayesian probability) may be used to reorder the nodes within the hierarchical list, such that the most commonly selected labels at each level of the hierarchy are placed in the most accessible positions within the spatial arrangement.

Advantageously, the order of the nodes in the hierarchical list is modified based on inputs previously received when the labels were displayed. The list modification component is be configured to modify the hierarchical list based on a combination of current user label selection information and historical user selection information. The current user label selection information may add to the historical user selection information (for example, by incrementing a frequency counter), which may be used to reorder the nodes within the hierarchical list.

Preferably, the hierarchical list component is configured to traverse a hierarchical list having references to at least one of: a text to be displayed, an image or an object. The hierarchical list component may be configured to traverse a hierarchical list in an eXtensible Markup Language (XML).

The control component may be configured to generate label display information based, at least in part, on next node information containing node order information.

Preferably, the spatial arrangement corresponds to a combination of current user label selection information and historical user label selection information.

Further, the spatial arrangement of the selectable labels preferably includes the size and position of the selectable label, the size and position of the selectable label based on a combination of current user label selection information and historical user label selection information.

The spatial arrangement may correspond to the physical layout of an input device such as a keyboard for example.

Preferably, the selectable labels relate to a task to be completed by a user.

### BRIEF DESCRIPTION OF THE DRAWINGS

Preferred embodiments of the present invention are hereinafter described, by way of example only, with reference to the accompanying drawings, wherein:

FIG. 1 is an illustration of a spatial arrangement of label positions which broadly corresponds to the layout of a conventional computer keyboard;

FIG. 2 is an illustration of the spatial arrangement of FIG. 1 including labels representing options relating to pizza;

FIG. 3 is an illustration of the spatial arrangement of FIG. 1 including labels representing options relating to pizza toppings;

FIG. 4 is an illustration of the spatial arrangement of FIG. 1 including labels representing options relating to Italian pizza toppings;

FIG. 5 is an illustration of the spatial arrangement of FIG. 1 including labels representing options relating to pizza dough;

FIG. 6 is an illustration of the spatial arrangement of FIG. 1 including labels representing options relating to yeast-free pizza dough;

FIG. 7 is an illustration of the hierarchy of options available to a user navigating the spatial arrangements of FIGS. 1-6;

FIG. 8 illustrates a series of spatial arrangements of labels displayed during a process of purchasing movie tickets;

FIG. 9 is illustrates a computing system for implementing the spatial arrangements of labels illustrated in FIGS. 1-9; and,

FIG. 10 is an exemplary hierarchical list, expressing in an XML format the hierarchy illustrated in FIG. 7.

### DETAILED DESCRIPTION OF THE INVENTION

Embodiments of the invention are suitable for operating a computer system having a user input mechanism and a display. The input mechanism may be separate from the display. For example, the input may be a conventional keyboard and mouse, and the display may be a conventional computer display. Alternatively, the input mechanism may be combined with the display. For example, some mobile telephone handsets include a touchscreen which simultaneously operates to display information to a user, and receive input from the user by means of fingers or stylii. Similarly, some recent keyboards incorporate a display beneath or in conjunction with the keys.

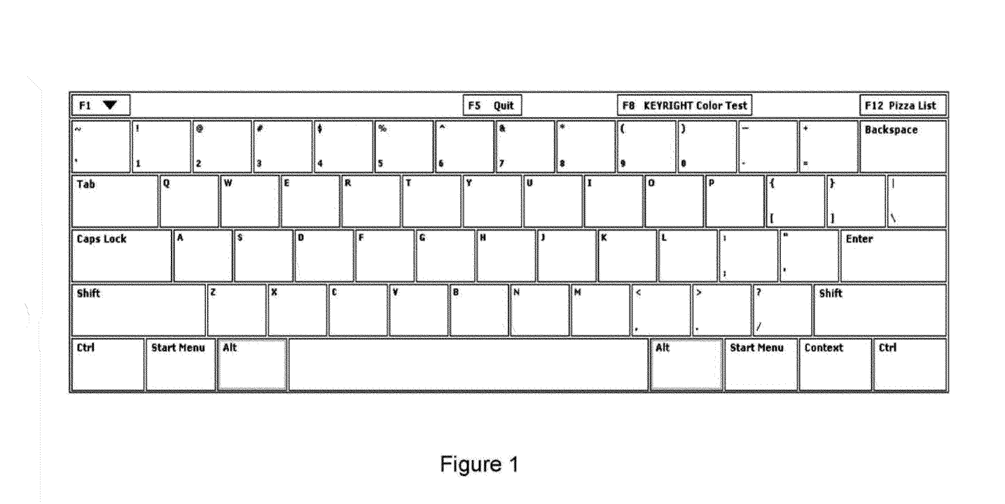

In one embodiment, the present invention involves the provision of a user interface. The user interface includes a predetermined spatial arrangement, which may be populated with dynamic labels. Preferably, but not necessarily, the predetermined spatial arrangement relates to the user input device. Although touchscreen user interface devices do not generally lead to a specific arrangement of dynamic labels, the labels should be able to be activated easily by means of a finger (that is, they must have an activation area large enough to facilitate activation by finger). Other user interface devices, such as keyboards, may lead to a user interface having dynamic labels that correspond broadly to the predetermined spatial arrangement of keys on a keyboard. The user interface having a predetermined spatial arrangement, which may be populated with dynamic labels, is illustrated in FIG. 1.

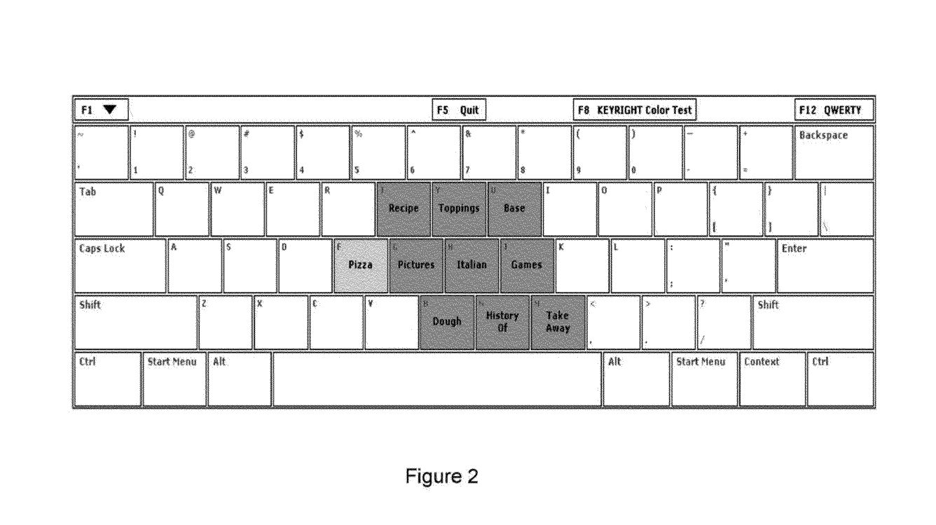

Upon initial activation, either automatically or by a user, a first plurality of selectable labels is displayed in a predetermined spatial arrangement. For example, as illustrated in FIG. 2, the first plurality of labels may relate to pizza, and are displayed in a predetermined spatial arrangement resembling a computing keyboard input device.

Preferably, the plurality of labels relate to actions which a user may desire to take. Although it is possible for the labels to relate to the mechanisms by which a task is undertaken, often users unfamiliar with software know the result they want to achieve, but do not know how they should achieve it.

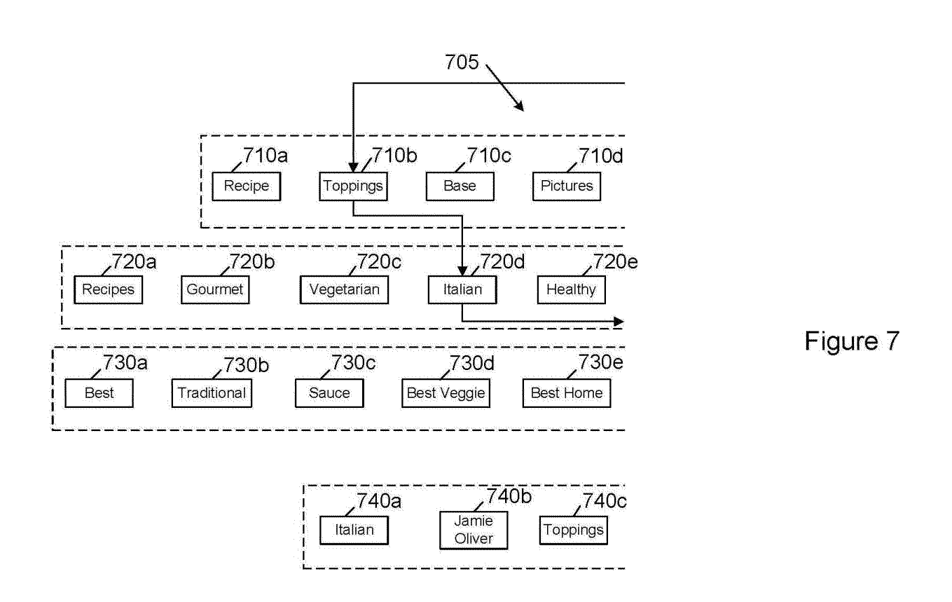

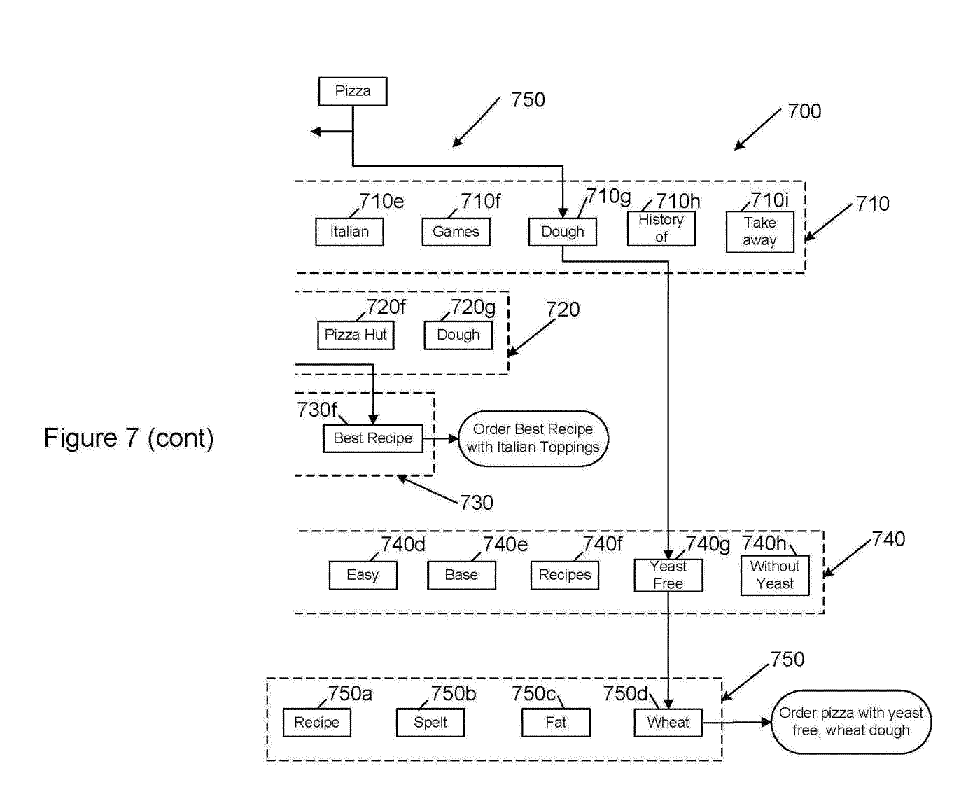

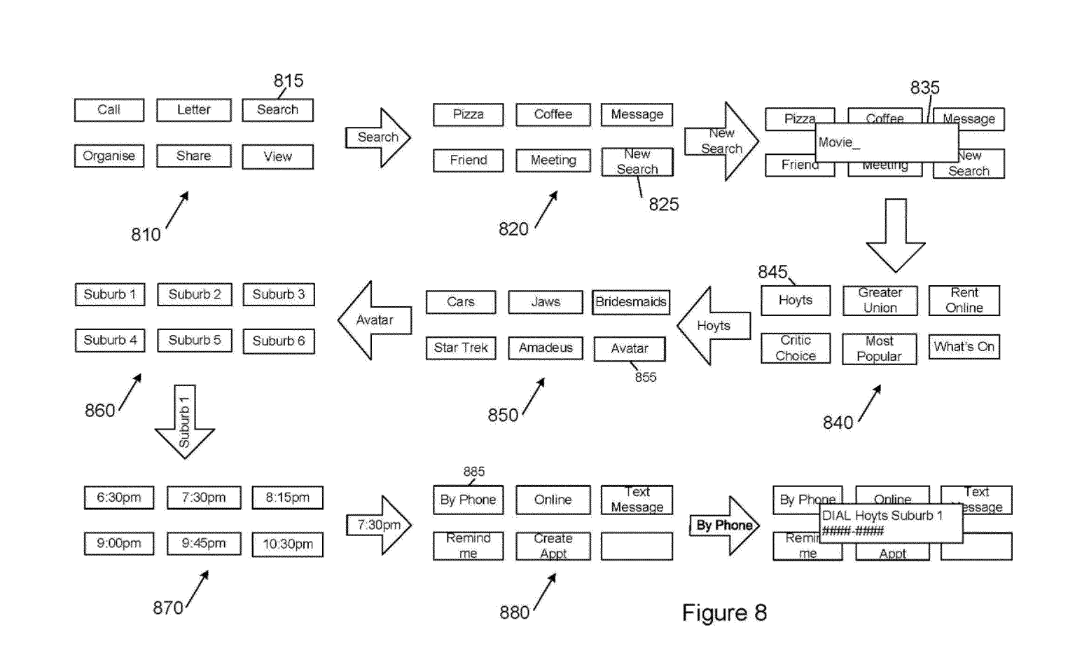

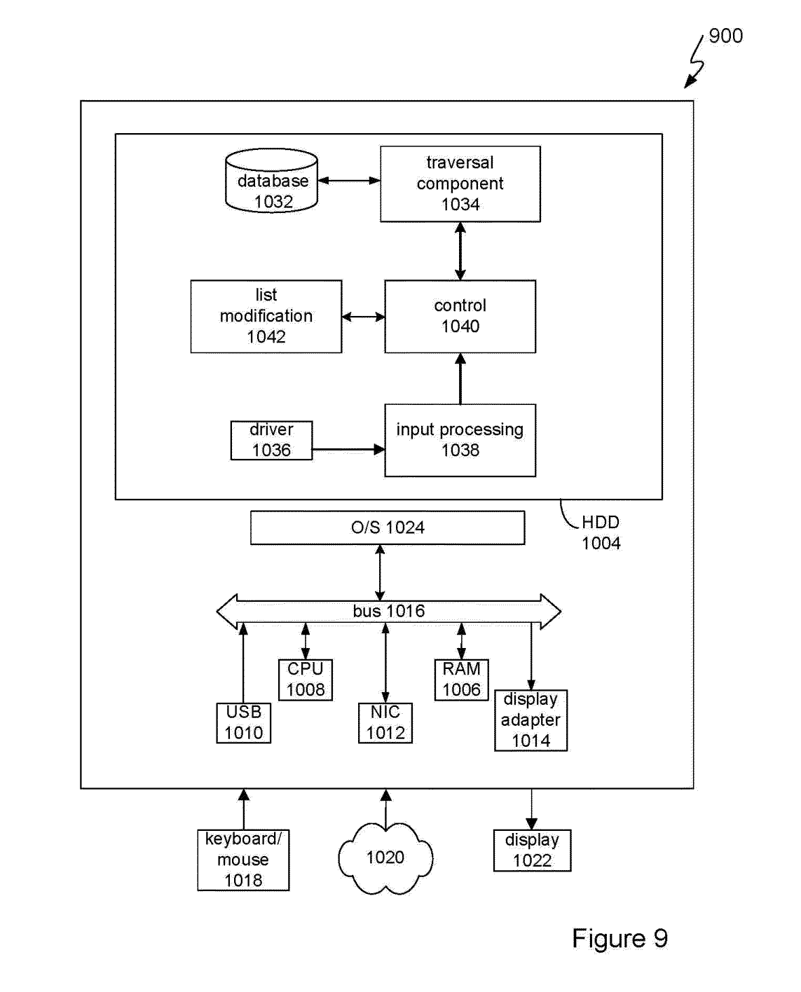

The first plurality of labels may be derived from a hierarchical list. FIG. 7 illustrates a hierarchy 700 used to populate the predetermined spatial arrangement illustrated in FIG. 2. The hierarchy 700 includes a parent level 710 having 9 parent nodes (not shown), each parent node being associated with a parent label 710a-710i. FIG. 2 illustrates a first plurality of selectable labels in a spatial arrangement, wherein each of the respective first plurality of labels corresponds to a respective parent label 710a-710i. To generate the spatial arrangement illustrated in FIG. 2, a hierarchical list traversal component 1034 (FIG. 9) retrieves a hierarchical list (representing the hierarchy illustrated in FIG. 7) from a hierarchical list storage component such as a database 1032. It traverses the list to identify the parent nodes, and their associated respective parent labels. This information is used by a control component 1040 to display the spatial arrangement of selectable labels using a display component (described below).

The spatial arrangement of labels illustrated in FIG. 2 is displayed using a display component including a display adapter 1014 and a display 1022, illustrated as part of computing system 1000 in FIG. 9. The display could be a liquid crystal-based display, a light emitting diode-based display or any other display capable of displaying a spatial arrangement of selectable labels.

The computing system 1000 also includes an input processing component 1038 which processes input data received from an input device driver 1036. In the exemplary system 1000 illustrated in FIG. 9, the input device is a keyboard/mouse 1018 connected via a USB connection 1010 to the rest of the computing system 1000. This input device, when operated by a user, sends signals to device driver 1036. Different types of input devices 1018 require different device drivers 1036. The device driver 1036 communicates with the input processing component 1038, which processes the information received from the device driver 1036 to generate user label selection information. This information identifies the one or more labels which have been selected by the user.

Returning to FIG. 2, a user may select one of the displayed labels, each of the displayed labels corresponding with a parent node in the hierarchy of FIG. 7 (and therefore corresponding with a parent label). The selection registers with the driver 1036, which transmits to input processing component 1038 information about the user's interaction with the input device 1018. The input processing component 1038 uses this information to generate user label selection information identifying the label that was selected by the user using input device 1018.

As described above, a user may select a selectable label in any manner. For example, a user may touch a label on a touchscreen-based device. The spatial arrangement of labels may resemble a computing keyboard (as illustrated in FIG. 1), in which case a user may select a label by pressing the corresponding key on the keyboard. Alternatively, a user may use a pointing device (such as a mouse or stylus) to select a label.

For example, the user may select the label “Toppings” (illustrated by line 705 in FIG. 7). The input processing component 1038 would receive information from driver 1036 enabling it to send to control component 1040 user label selection information identifying the “Toppings” label selected by the user.

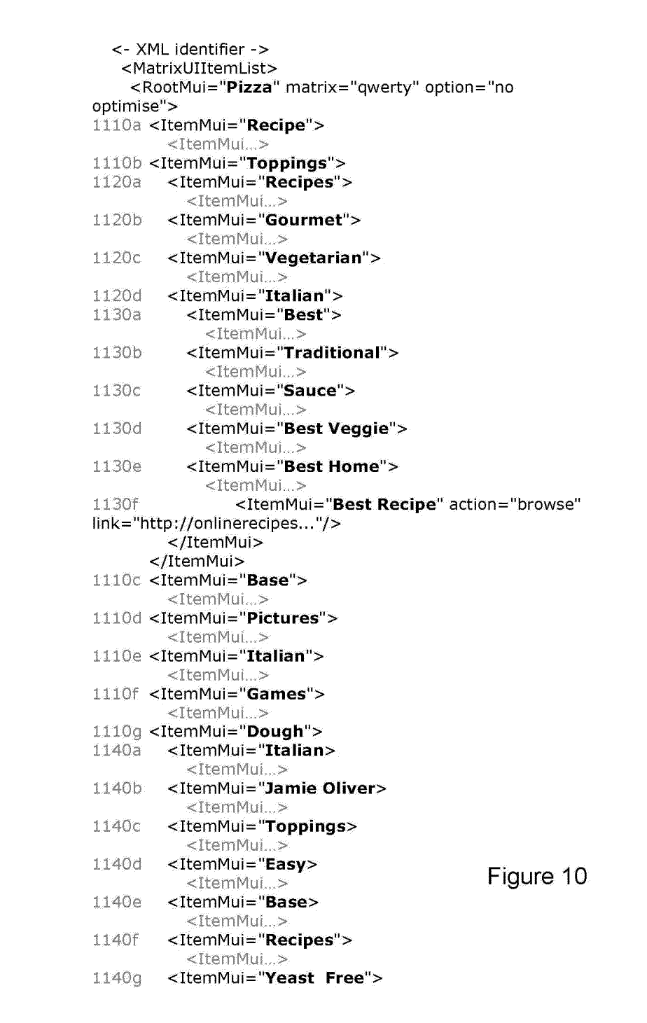

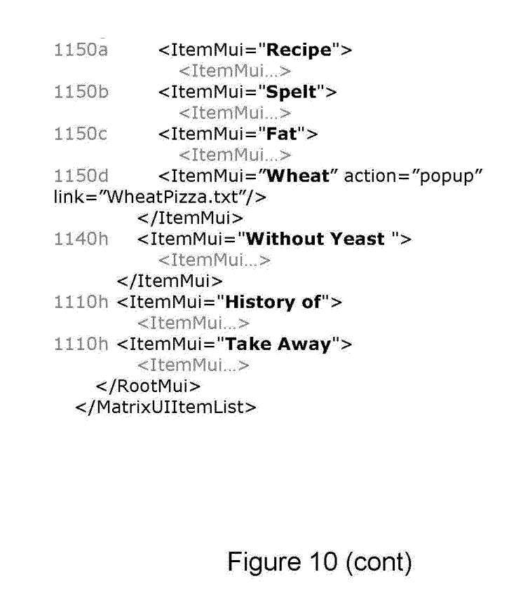

FIG. 10 shows a hierarchical list in an XML form, documenting a hierarchy corresponding to FIG. 7. Each node in the hierarchy is identified by a specific tag, in this case the <ItemMui> tag. There are tags representing each of the nodes relating to labels 710a-710i. For example, the node 1110a associated with the label “Recipe” is <ItemMui=Recipe“>. Similarly, the node 1110b associated with the label “Toppings” is <ItemMui=Toppings>. Node 1110b may be traversed by traversal component 1034 to retrieve next node information, being nodes 1120a-1120d associated with labels 720a-720d respectively.

Nodes within the hierarchy may be of different types. For example, node 1130f associated with label 730f (“Best Recipe”) is associated with an action (“SMS”), target number (“555-5555”) and content (“Best Recipe Italian Toppings to 1 Sesame Street, Newcastle”). The attributes of the node determine its type. If a node only has an associated label (in the form of text to be displayed), then it is a node representing user choices. However, if a node has an associated action, it is a node representing instructions executable by a computer processor.

The user label selection information generated by the input processing component 1038 is transmitted to control component 1040. If the user label selection information received by the control component 1040 indicates that the selected label is associated with a node representing instructions executable by a computer processor, the control component 1040 issues one or more instructions for execution by a computer processor (CPU 1008) based on information derived from the node. For example, if the user label selection information indicates that the selected label is label 730f, (associated with node 1130f) the control component 1040 issues an instruction causing the computer processor to send an SMS to the target number containing the content referred to by node 1130f. The action, target number and SMS content are examples of information derived from node 1130f.

However, if the user label selection information received by the control component 1040 indicates that the selected label is associated with a node representing user choices (that is, it is only associated with a label, and not any action), the control component 1040 generates and sends traversal instructions to the hierarchical list traversal component 1024 based on the user label selection information. The traversal instructions include instructions requesting the traversal component 1034 to traverse a hierarchical list (such as that illustrated in FIG. 10) and retrieve next node information. The next node information relates to one or more nodes dependent from the node in the hierarchical list corresponding to the selected label (for example, the “Toppings” label). As illustrated in FIG. 7, the next node information identifies nodes having corresponding labels of 720a and 720d (that is, the nodes that form part of group 720 illustrated in FIG. 7).

Upon receiving next node information from the hierarchy traversal component 1034, the control component 1040, uses the next node information to generate label information (that is information identifying the labels to be displayed, being the labels associated with nodes identified in the next node information). The control component 1040 sends this information to the display component (consisting of the display adapter 1014 and display 1022), which replaces the currently displayed labels (being those in group 710) with the labels identified by the label information (those in group 720).

In this way, the computing system 1000 displays a first plurality of selectable labels in a spatial arrangement and receives from an input device driver a selection of one of the first plurality of selectable labels. The computing system then replaces the first plurality of selectable labels with a second plurality of selectable labels (identified by the label information) each of the second plurality of selectable labels corresponding with respective child labels (being those identified in the XML list illustrated in FIG. 10).

The parent labels and child labels are those identified in the hierarchical list (an example of which is illustrated in FIG. 10). Each of the first plurality of selectable labels corresponds to a respective parent label. Usually, the selectable label will bear the same text as its corresponding parent label. However, the selectable label is not always the same and its corresponding parent label. For example, the selectable label may be an image file that graphically depicts an item relating to the corresponding parent label. In such circumstances, it is preferable for the node information to include a reference to the item (such as image) that will be used to form the selectable label. If an XML list is used to generate the hierarchy, the XML list may contain tags having references to images, text to be displayed, or other resources that could be used in the display of the selectable labels.

The process of receiving user input, generating user label selection information, determining that the associated node does not represent instructions executable by a computer processor (that is, it is a node that is not positioned at the end of a hierarchy, and has child nodes), parsing or traversing a hierarchical list to identify child nodes and displaying in a predetermined special arrangement a second plurality of selectable labels corresponding with respective child labels derived from the child nodes is repeated until the user label selection information identifies that a node representing instructions executable by a computer processor has been selected. That is, a hierarchical list is parsed, and sequential displays of options (in the form of a plurality of selectable labels) is displayed in a predetermined spatial arrangement until an end node of the hierarchical list is reached. The end node is associated with instructions executable by a computer processor and a selection by the user of the selectable label associated with that node results in the instructions being executed.

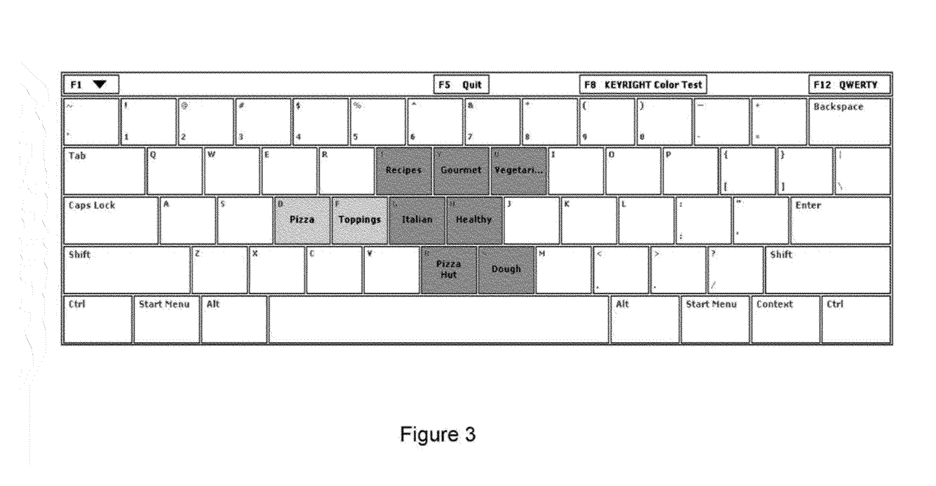

Two paths through an exemplary hierarchy are shown in FIG. 7. To initialize the display of selectable labels in the spatial arrangement, the hierarchical list is parsed, and selectable labels 710 are displayed (see FIG. 2). The user selects the “Toppings” label 710b (by pressing the Y key on their keyboard). As a result, the hierarchical list is parsed, and labels 720 replace labels 710 in the display (see FIG. 3). As shown in FIG. 3, the spatial arrangement may also provide an indication of historical user selections (the label on key F indicating that the user had previously selected “Toppings” label 710b.) If the user selects the “Italian” label 720d, the labels 720 being displayed are replaced with labels 730. Each of these labels are associated with end nodes, and user selection of “Best Recipe” label 730f results in an instruction being issued to order a best recipe pizza with Italian toppings.

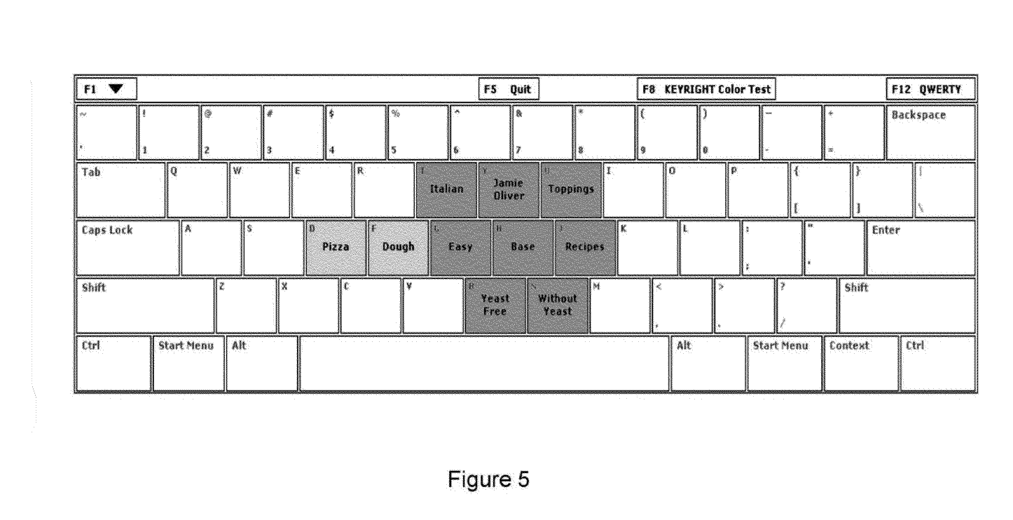

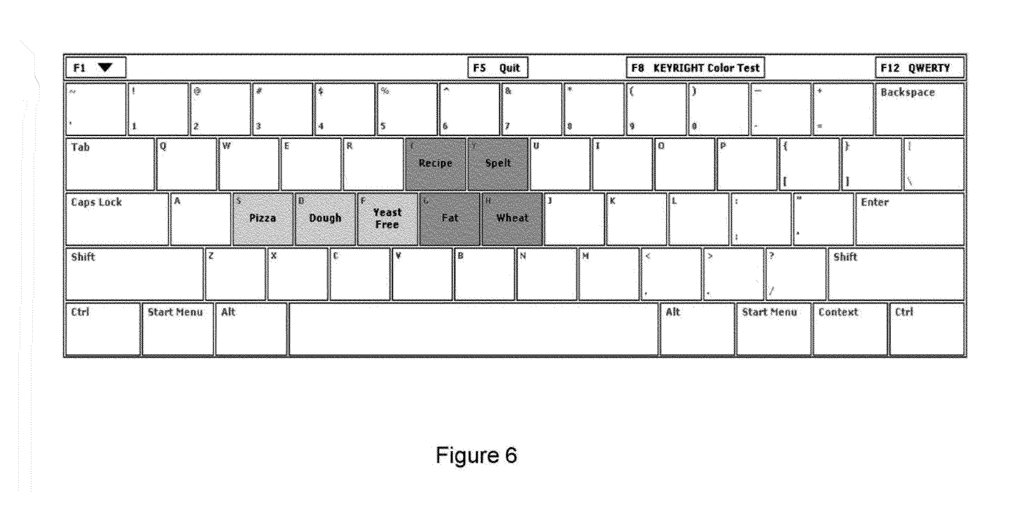

Alternatively, from the display illustrated in FIG. 2, the user may have selected “Dough” label 710i. The child level 740 of the parent node associated with “Dough” label 710i is different from the child level 720 of the parent node associated with “Toppings” label 710b. Accordingly, the plurality of selectable labels 710 illustrated in FIG. 2 is replaced by the selectable labels at child level 740 (FIG. 5). If the user selects the “Yeast Free” label 740g, the displayed selectable labels are replaced with those at child level 750 (FIG. 6). The nodes at child level 750 are end nodes, and selection of the “Wheat” label 750d results in the issuance of an instruction to order pizza with yeast free, wheat dough.

It will be appreciated that all child levels may be parent levels for their own child levels and, except in the case of the first level of a first list, all parent levels may be children of preceding levels. These relationships can also extend across lists. Lists may call lists, and what would be the top line of one list may serve as a child for another list.

Although an embodiment of the invention has been described above in relation to ordering a pizza, embodiments of the present invention may be used to issue any instruction for execution by a computer processor. For example, the instruction may be to display certain information. Alternatively, instruction may be to retrieve information, or undertake any file processing or other task.

FIG. 8 illustrates a series of spatial arrangements of labels, showing the replacement of a first plurality of selectable (parent) labels with a second plurality of a selectable (child) labels, the second plurality of selectable labels depending on user selection. As shown in arrangement 810, the user is presented with labels relating to a task the user may wish to perform. The user may select the “Search” label (815), causing the first plurality of selectable labels 810 to be replaced by a second plurality of labels 820. This second plurality of labels 820 identifies items for which the user may wish to search. For the next iteration of this process, the second plurality of labels 820 becomes a first plurality of labels. The user may select the “New Search” label 825. The node associated with this label may also be associated with an instruction for execution by a computer processor, the instruction being to generate a pop-up dialogue box (835) into which the user may enter a search term. The user may enter the search term “Movie”, which may result in a display of a further plurality of labels 840. This set of labels becomes the first plurality of selectable labels for the next iteration of the process. The user may select the “Hoyts” label 845, indicating that he or she wishes to see a movie at the Hoyts cinema. This results in the first plurality of selectable labels 840 being replaced by a second plurality of selectable labels 850. If the “Avatar” selectable label 855 is selected (the user indicating that they wish to see the movie titled “Avatar”), the plurality of selectable labels 850 will be replaced by a further plurality of selectable labels 860 identify the suburbs in which the movie “Avatar” is being shown at a Hoyts cinema. Upon selection of a suburb (more specifically, the selection of one of the selectable labels in the plurality of labels 860), the plurality of selectable labels 860 may be replaced by a further plurality of selectable labels 870 relating to the times at which the movie is being screened. User selection of a time results in the plurality of labels 870 being replaced by a further plurality of labels 880 relating to the method by which tickets to the movie may be purchased. These labels 880 are associated with end nodes representing instructions executable by a computer processor. The user selection of the “By Phone” label 885 results in the issuance of an instruction for a computer processor to call the Hoyts cinema in the chosen suburb and order a ticket to see the movie titled “Avatar”. It may do so by communicating electronically with a server at the cinema, or by initiating an interactive voice response conversation with a person at the cinema.

In the example described above and illustrated in FIG. 8, the input processing component receives input data relating not only to the labels which have been selected, but also what data has been entered by the user in response to a prompt. Such user-entered data is useful for applications where a search is required to be conducted, and the search term does not appear as one of the selectable labels. Entry of user-entered data may result in control component 1040 issuing an instruction for CPU 1008 to execute a search, and selecting a set of nodes within the hierarchical list that most closely match the search results.

Embodiments of the present invention are not confined to parsing a static hierarchical list. In some embodiments, particularly those that involve the execution of search, the hierarchical list may be generated, at least in part, based on user input. For example, where a user enters a search term (either by typing the term or selecting a selectable label containing the term) a search engine may be queried to retrieve common, popular, or potential additional terms which may be added to the user entered search term to further narrow the scope of the intended search. These potential additional terms are used to create a plurality of child nodes and corresponding child labels, which are subsequently used to populate the spatial arrangement.

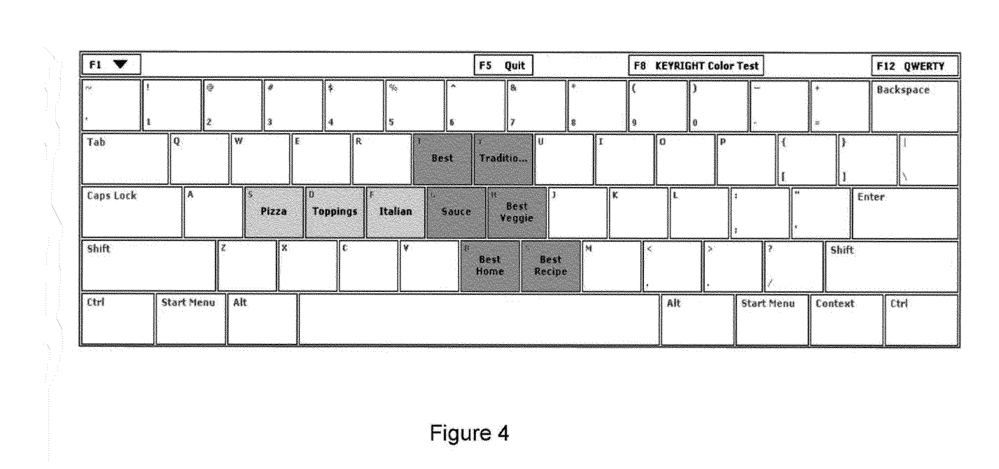

The positioning of the selectable labels in the spatial arrangement may be determined by the sequence in which the corresponding nodes are ordered in the hierarchical list. That is, the first plurality of selectable labels is displayed in a predetermined arrangement in an order determined, at least in part, by the order of the parent nodes within the parent level of the hierarchical list. The traversal component 1034 may traverse the hierarchical list, repeating the process of identifying a node and displaying the corresponding label until the level of the hierarchy being traversed is exhausted. Similarly, the second plurality of labels (which replace the first plurality of labels) may be displayed in an arrangement determined, at least in part, by the order of the child nodes within the child level of the hierarchical list. The examples described above with reference to FIGS. 2-7 illustrate the order of the displayed selectable labels being determined by the order of the nodes within the hierarchical list.

In some embodiments, the spatial arrangement of the selectable labels may be such that the labels in some label positions are easier to select than labels in other positions. For example, some label positions may be larger, and hence easier to activate. Other label positions may take less effort to reach (such as those in the centre of an arrangement, or those corresponding to the home keys of a computer keyboard). It can be useful to arrange the selectable labels so that the labels most likely to be selected are in positions where they are more easily selected.

For example, if a particular user most frequently orders Italian pizza (that is, selects label/node 720d), never orders Vegetarian pizza (720c), and orders other types of pizza only sometimes, it is preferable to have label 720d in a position most easily selectable, or a position allocated to the most popular choice. Label 720c should be in the label position that requires the most effort to activate.

Adopting this approach to dynamic label position allocation may involve modifying the hierarchical list to re-order the nodes within the list (and hence the position of the labels within the spatial arrangement). More specifically, it may involve modifying the order of the nodes within the hierarchical list based on one or both of the first selection (of the first plurality of nodes corresponding to parent labels) and second selection (of the second plurality of nodes corresponding to child labels), and storing the modified list in a computer readable storage medium (such as database 1032) for subsequent reuse.

As a relatively simple example, if a user selects label 710b, this label may be moved to the front of the list for the nodes/labels 710 (assuming that the nodes are ordered from most accessible/preferable to least accessible/preferable). If the user then selects label 720d, this label may be moved to the front of the list for the nodes/labels 720. The next time the user comes to order a pizza, they can easily order a pizza with Italian toppings, as the relevant options would have been positioned in the most easily selectable positions.

It is preferable if a more sophisticated algorithm (such as one based on Bayesian probability) is used to reorder the nodes within the hierarchical list, such that the most commonly selected labels at each level of the hierarchy are placed in the most accessible positions within the spatial arrangement. In this way, the order of the nodes in the hierarchical list is modified based on inputs previously received when the labels were displayed. In these embodiments, a list modification component 1042 (illustrated in FIG. 9) may be configured to modify the hierarchical list based on a combination of current user label selection information and historical user selection information. The current user label selection information may add to the historical user selection information (for example, by incrementing a frequency counter), which may be used to reorder the nodes within the hierarchical list.

Some embodiments of the present invention may be used to launch or operate software programs. For example, the action associated with an end node may be the command for launching software with some parameters. For example, a user might select a sequence of labels such as “Contact”-> “John”-> “Email”-> “Home”, at the end of which email software may be launched with John's home email address completed.

Alternatively the instruction issued by the control component 1040 may be an instruction to execute a function of a software program. For example, in a photo editing software application, a user may select a sequence of labels such as “Change colour”-> “Make warmer”-> “whole photo”-> “a little” to alter the colour temperature of a photograph.

In the described embodiment, the system 1000 is a standard computer system such as an 32-bit or 64-bit Intel Architecture based computer system, as shown in FIG. 9, and the aforementioned described processes may be implemented in the form of programming instructions of one or more software modules 1038, 1036, 1040, 1042 and 1034 stored on non-volatile (e.g., hard disk) storage 1004 associated with the computer system, as shown in FIG. 9. However, it will be apparent that at least parts of the software modules could alternatively be implemented as one or more dedicated hardware components, such as application-specific integrated circuits (ASICs) and/or field programmable gate arrays (FPGAs).

The system 1000 includes standard computer components, including random access memory (RAM) 1006, at least one processor 1008, and external interfaces 1010, 1012, 1014, all interconnected by a bus 1016. The external interfaces include universal serial bus (USB) interfaces 1010, at least one of which is connected to a keyboard and a pointing device such as a mouse 1018, a network interface connector (NIC) 1012 which connects the system 1000 to a communications network such as the Internet 1020, and a display adapter 1014, which is connected to a display device such as an LCD panel display 1022.

Many modifications will be apparent to those skilled in the art without departing from the scope of the present invention embodiments of which have herein been described with reference to the accompanying drawings. For example, although the embodiment above has been described in the context of standard computer, it could be implemented in any computing device which can drive a display, and contains an input mechanism. Furthermore, although a regular spatial arrangement has been described, there are no limitations on the nature of the arrangements of labels.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

The claims defining the invention are as follows:

1. A computer-implemented method for issuing an instruction, the method including the steps of:
parsing a hierarchical list, the hierarchical list including a parent level having one or more parent nodes, and a child level having one or more child nodes, the child level being associated with a selected one of the one or more parent nodes, wherein the one or more parent nodes are each associated with a parent label and the one or more child nodes are each associated with a child label:
displaying a first plurality of selectable labels in a spatial arrangement, each of the respective first plurality of labels corresponding to respective parent labels and the spatial arrangement corresponding to one or more predetermined criteria;
receiving, from an input device driver, a first selection of one of the first plurality of selectable labels;
replacing the first plurality of selectable labels in the spatial arrangement with a second plurality of selectable labels in a spatial arrangement, each of the second plurality of selectable labels corresponding to respective child labels, the spatial arrangement corresponding to a combination one or more predetermined criteria;
receiving, from the input device driver, a second selection of one of the second plurality of labels; and
issuing an instruction for execution by a computer processor based on the second selection.

2. The computer-implemented method as claimed in claim 1, wherein the predetermined criteria includes one or more of current user label selection information, historical user label selection information, user defined label selection or a combination thereof.

3. The computer-implemented method as claimed in claim 1, wherein the step of parsing a hierarchical list includes the step of parsing a hierarchical list having references to at least one of a text to be displayed, an image or an object.

4. The computer-implemented method as claimed in claim 1, wherein the spatial arrangement of the selectable labels includes the size and position of the selectable label, the size and position of the selectable label based on a combination of current user label selection information and historical user label selection information.

5. The computer-implemented method as claimed claim 1, wherein the step of displaying the first plurality of selectable labels in a spatial arrangement includes the step of displaying the first plurality of selectable labels in predetermined arrangement and in an order determined, at least in part, by the order of the parent nodes within the parent level of the hierarchical list.

6. The computer-implemented method as claimed in claim 1, wherein the step of replacing the first plurality of selectable labels with the second plurality of selectable labels includes the step of displaying the second plurality of labels in an arrangement determined, at least in part, by the order of the child nodes within the child level of the hierarchical list.

7. The computer implemented method as claimed in claim 1, further including the steps of:
modifying the order of the nodes within the hierarchical list based on one or both of the first selection and second selection;
storing the modified list in a computer readable storage medium for subsequent reuse.

8. The computer-implemented method as claimed in claim 7, wherein the step of modifying the order of the nodes within the hierarchical list includes modifying the order of the nodes based on inputs previously received when one or more of the first plurality of selectable labels and the second plurality of selectable labels have been displayed.

9. The computer-implemented method as claimed in claim 1, wherein the step of issuing an instruction includes the step of issuing an instruction to launch a software program.

10. The computer-implemented method as claimed in claim 1, wherein the step of issuing an instruction includes the step of issuing an instruction to execute a function of a software program.

11. The computer-implemented method as claimed claims 1, wherein the step of issuing an instruction includes the step of issuing an instruction to execute a search query, the contents of the query being determined, at least in part, by the second selection.

12. The computer-implemented method as claimed in claim 8, wherein the selectable labels represent refinements of a search query.

13. The computer-implemented method as claimed in claim 1, wherein the spatial arrangement corresponds to the physical layout of an input device.

14. The computer-implemented method as claimed in claim 1, wherein the selectable labels relate to a task to be completed by a user.

15. A system for issuing an instruction for execution by a computer processor, the system including:
a hierarchical list traversal component for traversing a hierarchical list, the list including a hierarchy of nodes representing user choices, and a plurality of nodes at the bottom of the hierarchy representing instructions executable by computer processor;
a display component for displaying a predetermined spatial arrangement populated with labels based on received label information;
an input processing component for processing input data received from an input device driver and generating user label selection information;
a list modification component for modifying a hierarchical list based on user label selection information, wherein the list modification component is configured to modify a hierarchical list based on one or more predetermined criteria; and
a control component for;
receiving user label selection information from the input processing component, the user label selection information identifying a selected label;
if the selected label is associated with a node representing instructions executable by a computer processor,
issuing one or more instructions for execution by a computer processor based on information derived from the node,
otherwise,
sending traversal instructions to the hierarchical list traversal component based on the user label selection information;
receiving next node information from the hierarchical list traversal component, the next node information relating to one or more nodes dependent from the node in the hierarchical list corresponding to the selected label; and
generating label information from the next node information, and sending the label information to the display component.

16. The system as claimed in claim 15, wherein the predetermined criteria includes one or more of current user label selection information, historical user label selection information, user defined label selection or a combination thereof.

17. The system as claimed in claim 15 wherein the hierarchical list component is configured to traverse a hierarchical list having references to at least one of: a text to be displayed, an image or an object.

18. The system as claimed in claim 15, wherein the hierarchical list component is configured to traverse a hierarchical list in an eXtensible Markup Language (XML).

19. The system as claimed in claim 15, wherein the control component is configured to generate label display information based, at least in part, on next node information containing node order information.

20. The system as claimed in claim 15, wherein the spatial arrangement corresponds to a combination of current user label selection information and historical user label selection information.

21. The system as claimed in claim 17, wherein the spatial arrangement of the selectable labels includes the size and position of the selectable label, the size and position of the selectable label based on a combination of current user label selection information and historical user label selection information.

22. The system as claimed in claim 15, wherein the spatial arrangement corresponds to the physical layout of an input device.

23. The system as claimed in claim 15, wherein the selectable labels relate to a task to be completed by a user.
